(19) United States
(12) Patent Application Publication
(10) Pub. No.: US 2012/0195768 A1
(43) Pub. Date: Aug. 2, 2012

(54) OFFSHORE WIND TURBINE INSTALLATION

(75) Inventors: Cornelis Pieter Aartdrianus Van Nood, Delft (NL); Halewijn Jochem Boonstoppel, Den Haag (NL)

(73) Assignee: SBM Schiedam B.V.

(21) Appl. No.: 13/318,316

(22) PCT Filed: Apr. 29, 2010
(86) PCT No.: PCT/NL10/50249

§ 371 Date: Jan. 13, 2012

(30) Foreign Application Priority Data
May 1, 2009 (EP) 09159272.5

(51) Int. Cl. F03D 11/00; B60P 7/06; B23P 11/00

(52) U.S. Cl. 416/244 R; 29/428; 410/44

(57) ABSTRACT

This invention relates to a Method of mounting a wind turbine at a mounting location, said method comprising the steps of mounting two rotor blades to a pre-assembly of hub and nacelle; lifting the assembly of nacelle, hub and two blades by means of an installation crane on top of a frame in which a third rotor blade is held in vertical position with a flange pointing up; manipulating the third rotor blade towards the hub of the assembly resting on the said frame, allowing the third rotor blade to be mounted to the assembly of hub and nacelle and two blades; lifting the completed wind turbine assembly of nacelle, hub and three blades on top of a pre-installed wind turbine foundation tower.

### FIELD OF THE INVENTION

The present invention relates to a method for safe and controlled offshore installation of wind turbine parts, especially the blades, on high elevation by use of special frames. It also relates to the specific design aspects of the frames and handling tools that are required to make the installation method possible. The present invention relates to installation method of any type of offshore wind turbines including bottom-fixed wind turbines and floating wind turbines.

### BACKGROUND OF THE INVENTION

Installation of offshore wind turbines is done in most cases by installing the assembly in separate parts. These parts are normally lifted by a crane and comprised of:
a vertical tower or several tower sections
a nacelle housing the generator and gear box
a hub that will hold the blades, connected to the shaft of the generator or gear box
blades, normally 3

Wind turbines are installed on land and relatively recently offshore at sea. As described in international patent publications WO0248547 and WO03093584, in order to provide a stable working platform for offshore installation of wind turbines frequently jack-up barges or jack-up vessels are being used, further called platform or jack-up. These jack-ups are provided with vertical legs that can be lowered to the seabed. The platform can then be jacked-up out of the water along the legs. In some areas jacking up or transfer to another position is only possible in certain cyclic periods like tidal currents. For the installation cycle it is important to stay within these cyclic periods, requiring a high level of installation efficiency. The jack-up is generally equipped with a crane to install the wind turbine parts on a foundation installed on the seabed. The foundation is partly extending above the water level.

As disclosed in international patent publications WO0248547 and WO2004070119, a general installation sequence is to lift the tower or tower sections on the foundation.

Other options are also proposed, as in the patents GB2407114 and U.S. Pat. No. 7,112,010 where it is disclosed that the nacelle is installed separately, followed by the hub with all blades already fixed to the hub. In that case the hub with blades lies in horizontal position on the platform deck and needs to be installed in a vertical plane, so the assembly of hub and blades needs to be rotated.

In another patent application US2007/266538, in order to minimize offshore lifts, the nacelle, hub and two of the three blades are assembled onshore in what is referred to as a “bunny ear” configuration and transported to site. This assembly comprising the nacelle with the hub and two blades pointing upward is lifted into place and the final lift is used for the third blade, which is bolted into the hub.

In another patent application WO2009041812 filed by the applicant, there is disclosed a method where two blades in a bunny ear configuration are lifted, the third blade being assembled to the hub and bunny ears assembly in the crane before installing the complete turbine on the top of the tower. Although this method is advantageous, the onshore assembled bunny ears require significant deck space, and the mounting of the third blade in the crane requires significant handling operations to position and up-end the blade.

Due to the variable wave loading on the legs and the flexibility of the jack-up system the platform in jacked-up condition moves slightly in the horizontal plane. This movement combined with the flexibility of the crane and local wind conditions can cause significant horizontal movement of lifted parts compared to the earth-fixed foundation or other parts already installed on the earth-fixed foundation. Experience has shown that, due to the motions and wind, installation of the last blade (usually the third blade) may be difficult and potential impacts of the vulnerable blade on already installed parts can cause costly damages to the blade. Installation as described in patent applications GB2407114 and U.S. Pat. No. 7,112,010 avoids the installation of a loose vulnerable blade, however, there is hence a need to rotate an assembly of hub and blades, which is complex due to the large dimensions of the assembly and vulnerability of the blades, especially in windy environmental conditions.

There is also another solution as the one disclosed e.g. in international patent application WO0248547, where installation of the assemblies of tower, nacelle, hub and blades is done in one lift by e.g. jack-ups or by floating crane vessels, the latter normally allowing transport and lift of one turbine at a time. However, this solution requires large and costly lifting equipment, involves complex logistics for transport of completed turbines to the installation site, can in case of floating operations only be done in a limited weather window and is with the presently available installation equipment not expected to be economically feasible for installing large numbers of turbines in short time.

The known procedures for installing wind turbines, especially offshore, show room for improvement, also in light of the expected growth in number, size and power of the wind turbines that need to be installed in the future. The installation method of offshore wind turbines is by the invention optimized resulting in a shorter installation cycle.

### SUMMARY OF THE INVENTION

An object of the present invention is to provide a method of mounting a wind turbine at a mounting location, said method comprising the steps of:
mounting simultaneously or sequentially two rotor blades to the pre-assembly of hub and nacelle by means of a blade handling tool or tools
lifting the assembly of nacelle, hub and two blades by means of an installation crane on top of a frame in which a third rotor blade is held in vertical position with the flange pointing up
manipulating the third rotor blade towards the hub of the assembly resting on the said frame, allowing the third rotor blade to be mounted to the assembly of hub and nacelle and two blades
lifting the completed wind turbine assembly of nacelle, hub and three blades on top of a pre-installed wind turbine foundation tower.

It is also an object of the present invention to provide blade holding frames with blades in vertical position which frames are suitable for holding multiple blades in such position during transportation on an installation vessel.

The present invention also provides handling tools which hold and manipulate the vertically stored rotor blades (with flanges pointing downwards) in the required degrees of freedom allowing the rotor blade to be fitted to the assembly of nacelle and hub and handling tools which hold and manipulate vertical rotor blade (with flange pointing upwards) in the required degrees of freedom allowing the rotor blade to be fitted to the assembly of nacelle and hub and several blades.

The present invention also relates to an installation vessel with a deck layout where pre-assembled nacelle and hub without blades are positioned approximately in the center line of the vessel and the blade holding frames with blades positioned upright (with the flange pointing downwards) positioned at both sides of the vessel, so that the pre-assembled nacelle and hub without blades are standing in the middle between the frames.

According to the present invention, the method and system proposed improve the duration of the offshore installation of the wind turbine parts, as well as create a safer and more controlled installation of wind turbine parts during offshore installation. Further, with a reduced number of handling activities and lifts successively compared to known installation methods, with less crane movements, and simultaneously assembly of parts of the wind turbines offshore on the platform deck, the proposed solution provides a cost effective and time efficient installation method of offshore wind turbines with a high level of flexibility for onshore and offshore logistics.

The frames used to hold the blades and the handling tools are suitable for holding and handling the blades for multiple wind turbines thus allowing the wind turbine installation vessel to carry components for multiple wind turbines in one journey without the need for additional blade handling or positioning for each turbine installation sequence.

The frames used to hold the blades vertically (flanges pointing upwards), are outfitted to allow personnel access to all relevant areas of the blades in order to monitor, control the blade and its handling tools while fitting the third blade in the assembly of nacelle, hub and two blades.

### BRIEF DESCRIPTION OF THE DRAWINGS

The invention will be further described below in connection with exemplary embodiments with reference to the accompanying drawings, wherein

FIG. 1 shows a front view of the pre-assembled nacelle and hub without blades

FIG. 2 shows the installation vessel deck layout according to one embodiment of the present invention, alternative layouts with similar functionality are possible

FIG. 3 shows the lifting from onshore to the deck of one blade loaded in a blade holding frame with flange pointing downwards

FIG. 4 shows the lifting from onshore to the deck of one blade loaded in a blade holding frame with flange pointing upwards

FIGS. 5 to 7 show the different steps of the mounting of the two rotor blades to the pre-assembly of hub and nacelle according to the present invention by use of blade handling tools

FIGS. 8 to 10 show the lifting the assembly of nacelle, hub and two blades according to the present invention

FIGS. 11 to 13 show the manipulation of the third rotor blade towards the hub of the assembly resting on the third blade holding frame, allowing the third rotor blade to be mounted to the assembly of hub and nacelle and two blades by use of a blade handling tool

FIG. 14 shows the lifting of the completed wind turbine assembly of nacelle, hub and three blades on top of a pre-installed wind turbine foundation tower.

FIG. 15 shows an alternative carrousel shaped blade holding frame which can rotate a new blade in the handling position within reach of the blade handling tool.

FIG. 16 shows a top view of the handling tool of FIG. 15

FIG. 17 shows the mounting of the third rotor blade to the assembly of hub and nacelle and two blades using a similar carrousel type blade frame as shown in FIGS. 15 and 16.

It must be noted that the total number of blades that can be held in a blade holding frame, either carrousel type or differently, can vary from the number of three as shown in the drawings, depending on the specific logistical and installation requirements of each installation operation.

As shown in FIG. 2, according to the present invention the deck layout is different than the typical arrangements known by current offshore wind turbine installation methods.

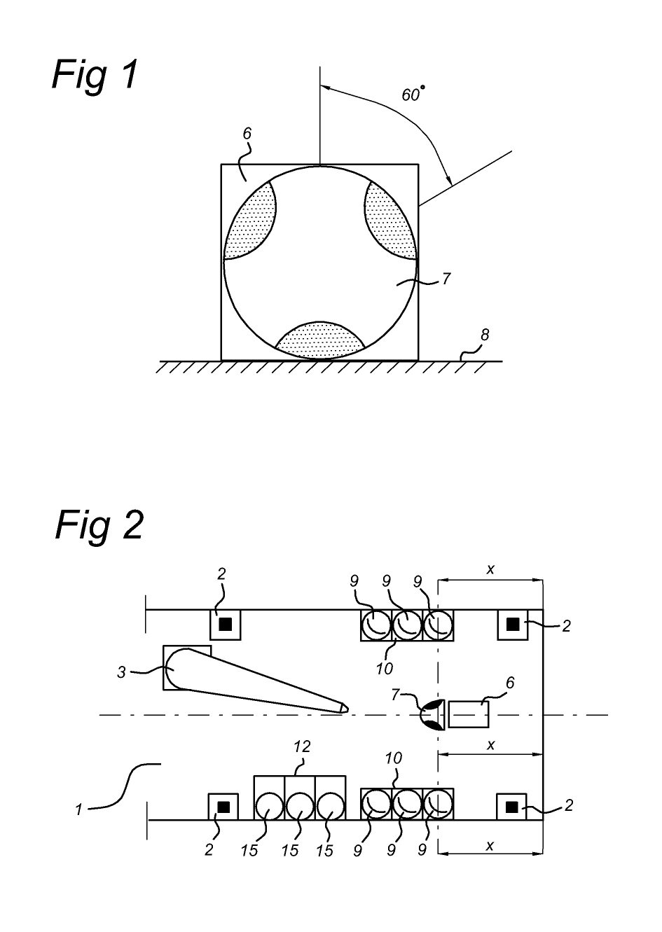

The pre-assembled nacelle and hub without blades as shown in FIG. 1 are pre-assembled with the hub already rotated in a bunny ear position. Two blades positioned upright with the flange pointing downwards 9 in two separate rigid frames 10 are placed at both sides of the vessel 1 with the nacelle 6 standing in a predefined position in the middle of the frames. The last blade is positioned upright with the flange pointing upwards 15 in a third rigid frame 12 which is accessible for personnel on different levels. The vessel is a jack up vessel with four legs 2.

As the blades with the flange pointing downwards 9 are the blades to be installed first on the hub in a bunny ear configuration, their position is a key aspect of the installation according to the present invention and the two blade holding frames 10 with the vertical blades 9 with the flange pointing downwards including blade handling tools 11 need to be aligned at both sides of the wind turbine installation vessel 1.

The blades with the flange pointing upwards 15 are the additional blades which are installed in a later phase according to the present invention.

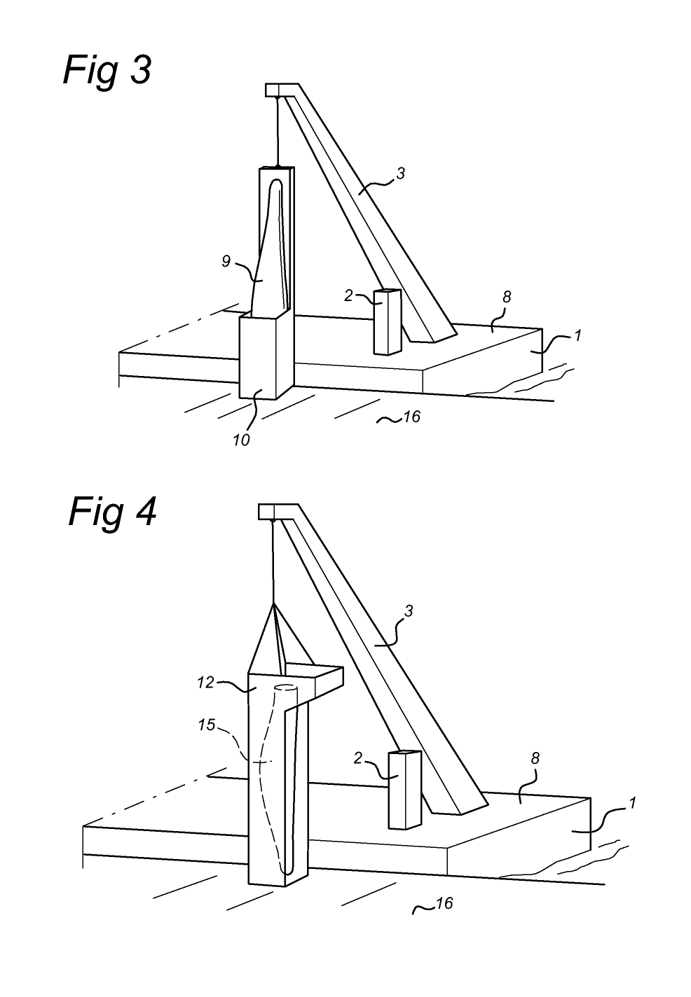

A crane 3 installed on the deck of the vessel 1 is used to position the components on a predefined position on the jack-up vessel 1. FIG. 3 shows the lifting from onshore 16 to the deck of the jack-up vessel 1 of one blade with flange pointing downwards 9 loaded in a blade holding frame 1 and FIG. 4 shows the lifting from onshore 16 to the deck of the jack-up vessel 1 of one blade with flange pointing upwards 15 loaded in a blade holding frame 12. The frames 10, 12 are preloaded onshore with a set of blades 9, 15. Preferably the frames 10 and 12 are the same frames or make use of the same frames that are used for transporting the blades from manufacturer to the onshore assembly site or quayside.

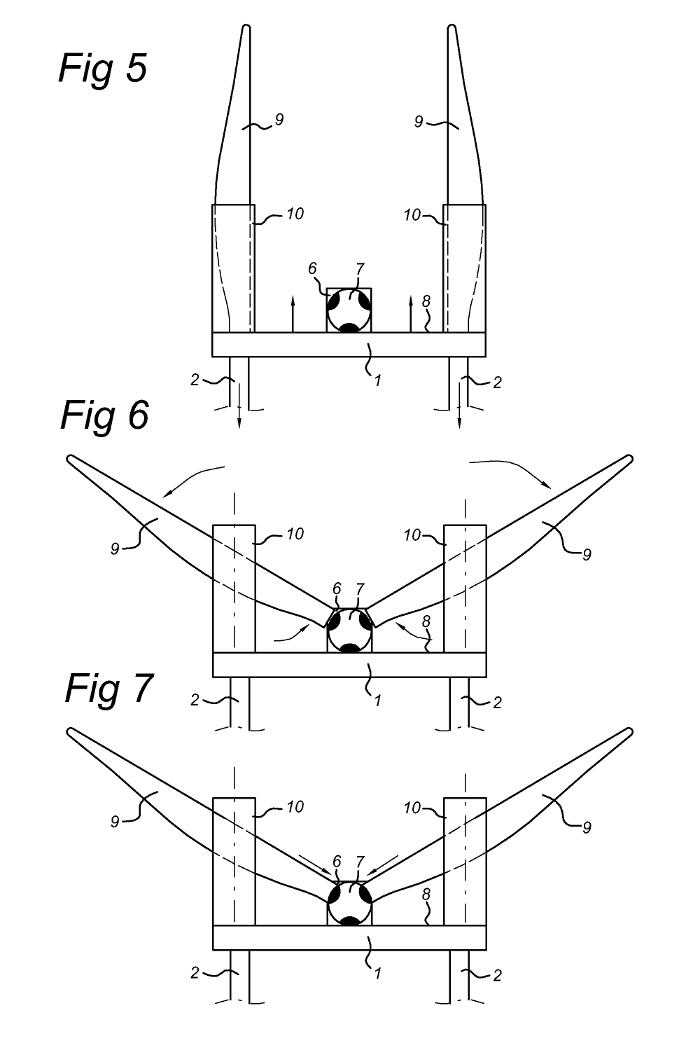

FIGS. 5 to 7 show the different steps of the mounting of the two rotor blades 9 to the pre-assembly of hub 7 and nacelle 6 according to the present invention. Once the vessel 1 arrives at the installation site, it is jacked up. After the installation vessel 1 is jacked up, the two upper blades 9 of the bunny ear configuration are assembled to the hub 7. The two blades are rotated 60 degrees by handling tools 11 (not shown) from an upright transport position into the bunny ear configuration, flanges pointing to hub. The blade holding frame 10 has an internal or external handling tool 11 which is capable to rotate the blade 60 degree and manipulate the blade position such that the blade flange is aligned with the upper holes of the hub 7. The blade handling tools can operate simultaneously for two blades and are capable to insert the blades 9 in the hub 7, and the blades 9 are mounted in the hub 7 creating a bunny ear configuration.

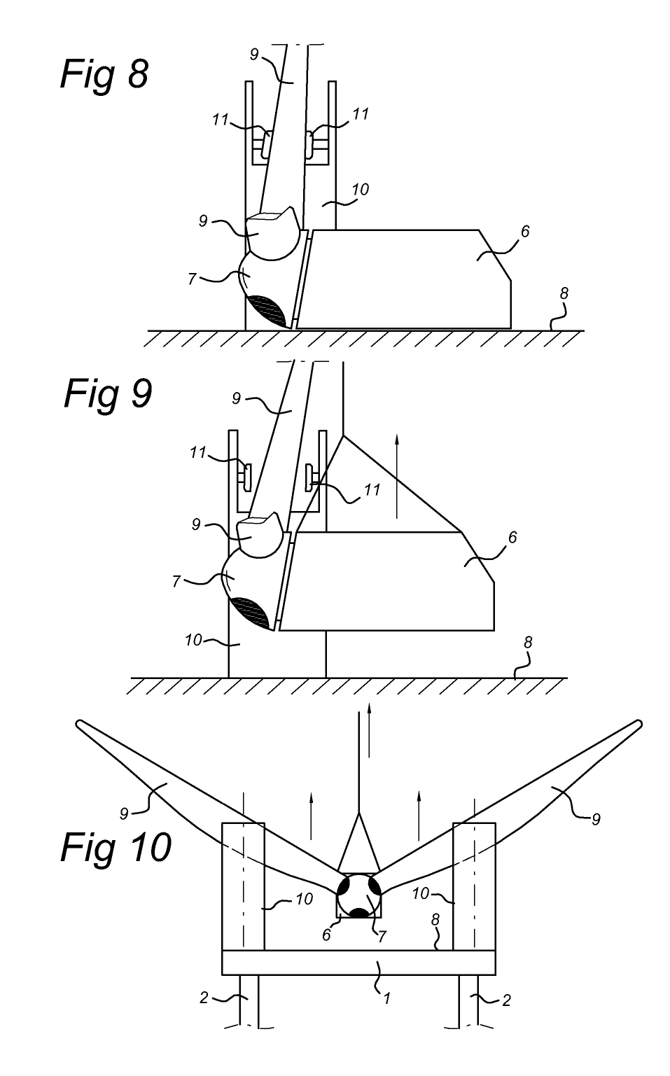

As shown in FIGS. 8 to 10, when the blades 9 are mounted to the hub, the blade handling tools 11 release the blades 9 and give the blades 9 a clear exit to be lifted vertically.

As mentioned earlier, the position of the blades 9 on the deck is a key aspect, in fact as the nacelle assembly 6, 7 is located at a predefined longitudinal position at or near the platform centerline aligned with the two frames 10 containing the blades 9 with the flange pointing downwards, the mentioned operation can be done for both blades 9 simultaneously.

Alternatively pre-assembled bunny ears (nacelle, hub and two blades) can be loaded from the quayside on the platform deck. This is however less deck space efficient and can have impact on navigation due to blades sticking outside the vessel perimeter. In addition transport loads on bunny ear assemblies may have negative impact on the integrity of the components.

Another advantage of the installation method according to the present is that the main crane 3 is not needed during the mounting of the two first blades 9 on the hub 7 so it is possible to schedule this operation during installing the vertical tower 5. Hence, the installation of the vertical tower 5 begins once the vessel 1 is jacked up.

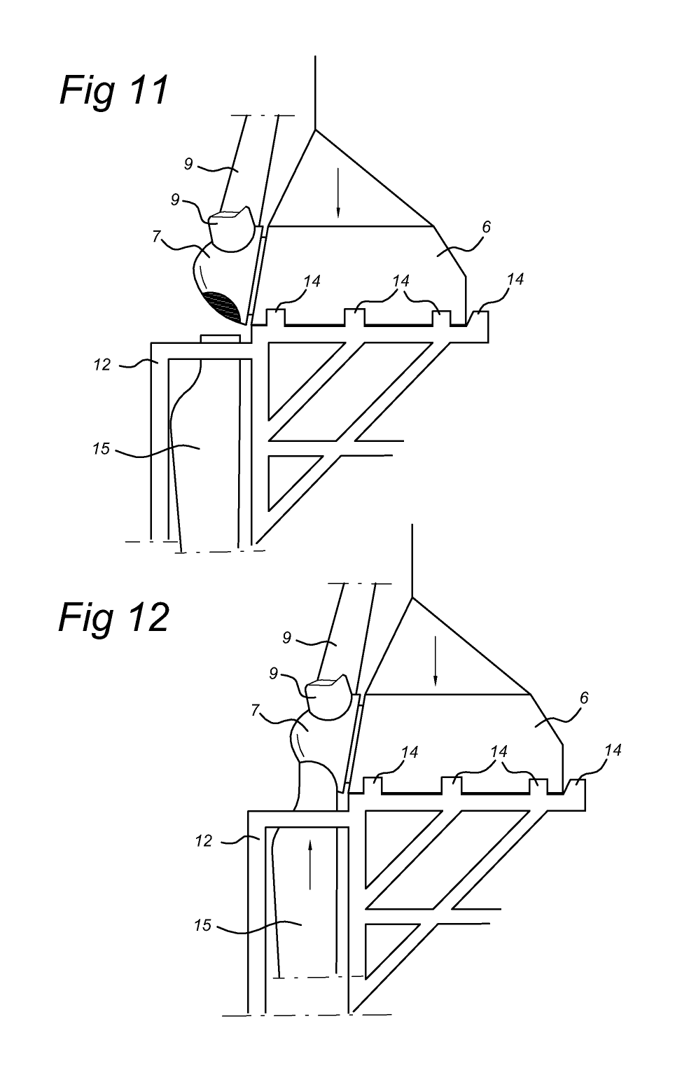

After the main crane 3 is finished with installing the vertical tower 5, it can pick up the assembled bunny ear (FIG. 10) and position it on top of the third frame 12 which contains the third blade 15 (FIG. 11).

FIGS. 11 to 13 show the manipulation of the third rotor blade 15 towards the hub 7 of the assembly resting on the third blade holding frame 12, allowing the third rotor blade 15 to be mounted to the assembly of hub and nacelle and two blades.

On top of the third frame 12 supports, guides and bumpers 14 are fitted such that the bunny ear assembly is supported by the frame 12 and all movement is suppressed. The third blade holding frame 12 has internal or external blade handling tools 13 which are capable to position the blade in the bunny ear assembly with the required degrees of freedom. The third blade 15 with the flange pointing upwards can be inserted in the hub 7 by a handling tool 13 to complete the assembly of the turbine. (FIG. 12)

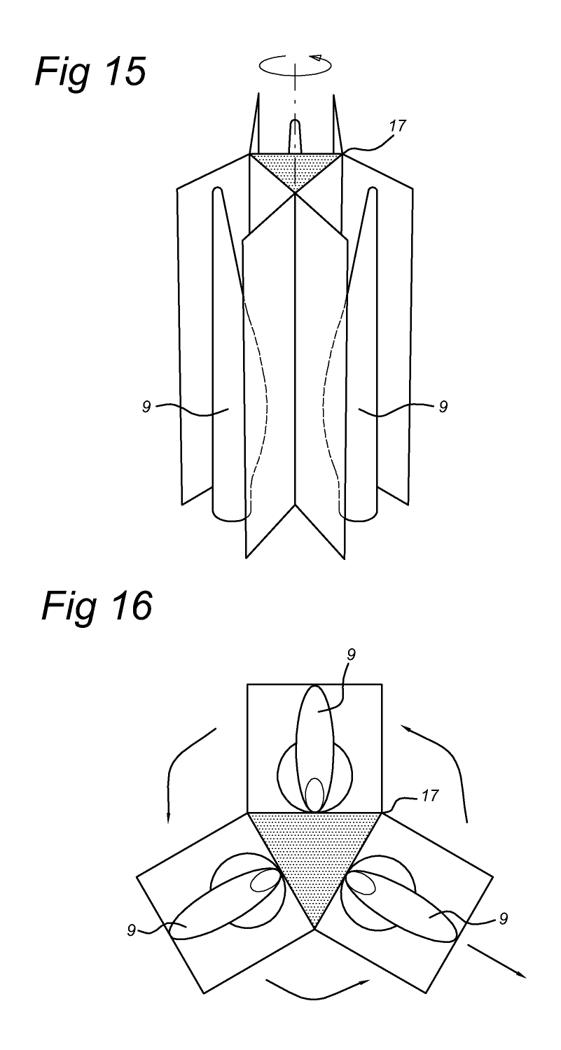

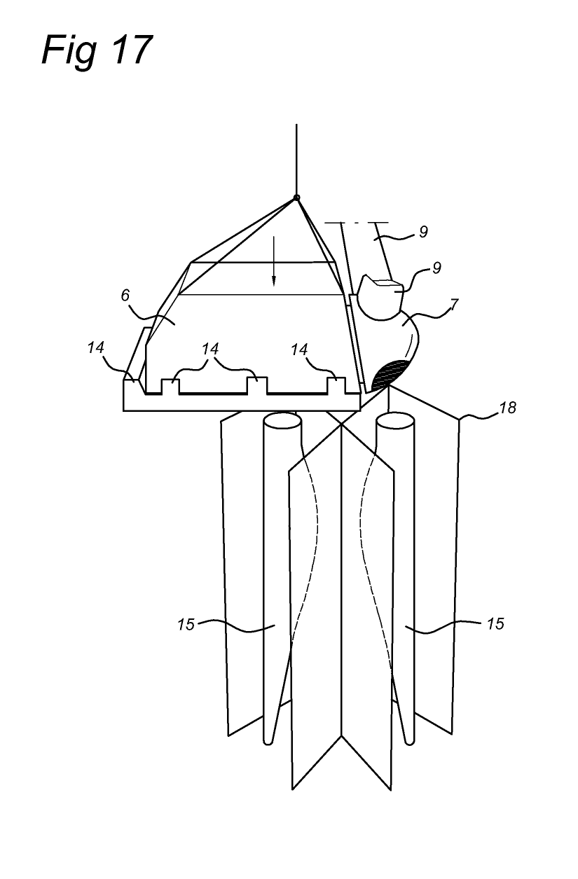

The above sequence describes the method and installation tools for installation of one turbine. Components for multiple turbines can be handled and stored similarly, e.g. by frames 10 and 12 holding multiple blades. Alternatively, as shown in FIGS. 15 to 17, with the use of a carrousel shaped frames, the blade can be placed in the handling position by turning the carrousel so that it turns the new blade in the requested position. The central and rotating parts of the carrousels can be permanently mounted on the vessel deck, while the blades 9 and 15 and frames 10 and 12 are lifted on these rotating parts. Alternatively complete carrousels 17 and 18 including rotating part and blades can be lifted on deck. Such carrousels can be outfitted for any number of blades.

At the top of the frame 12 and at other required levels there are save working decks (not shown), such that personnel are close to the insertion of the last blade to control and monitor correct handling of the blade. After the last blade 15 is mounted in the hub 7, the blade 15 can be released in a controlled manner.

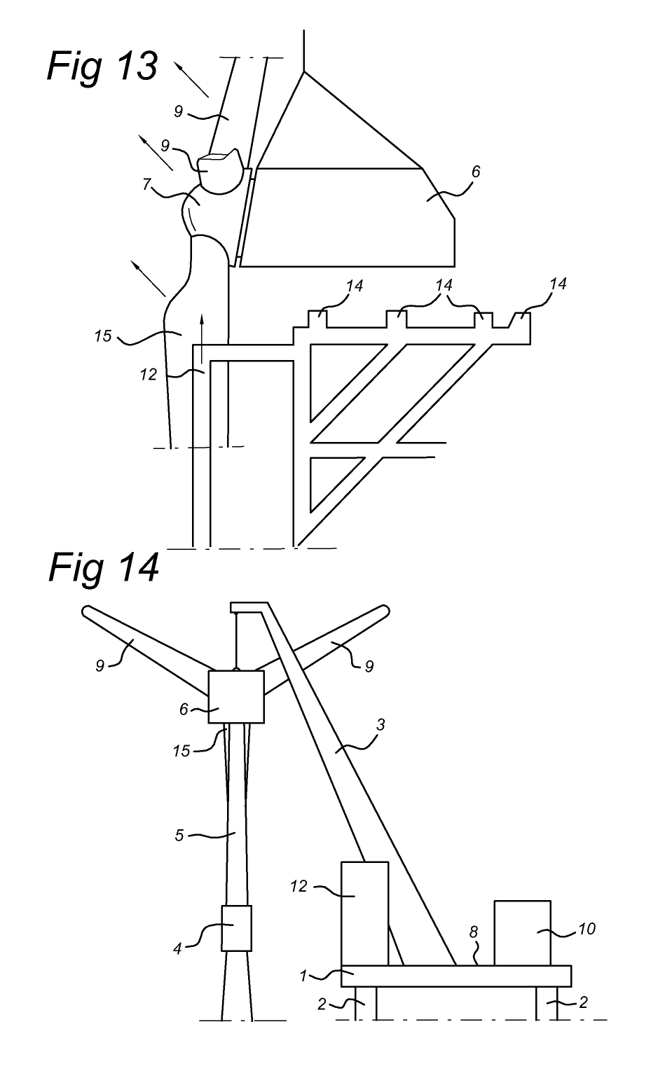

As shown in FIG. 13 the complete turbine assembly is lifted out of the supports 14 and the third blade 15 can exit the frame 12 horizontally as well as vertically due to the (partly) u-shape of the frame. The movement of the third blade 15 can be monitored and controlled by personnel and e.g. tugger lines on working decks at different levels in the frame in order to prevent direct contact of the assembly to the frame 12.

FIG. 14 shows the lifting of the complete turbine including the last installed blade on top of the pre-installed wind turbine foundation tower 5.

The installation method proposed ensures a safe and controlled installation of the blades as all parts are fully fixed to the frames 10, 12 or relative to the frame 10, 12 and platform deck 8 during installation, and personnel are able to be close to installation operations for monitoring and controlling of movements, so there are no uncontrolled relative movements and no risk of significant uncontrolled impact.

The figures only show a situation where only three blades are installed on the hub, however it should be understood that this is not limiting the scope of the present invention and that the invention can be used for any other numbers of blades.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1-20. (canceled)

21. A method of mounting a wind turbine, comprising:
(a) mounting at least two rotor blades to a pre-assembly of hub and nacelle to form an assembly;
(b) lifting the assembly by an installation crane on top of a frame in which a third rotor blade is held in vertical position with the flange pointing upward;
(c) mounting the third rotor blade to the assembly to form a wind turbine;
(d) lifting the wind turbine on top of a pre-installed wind turbine foundation tower.

22. The method according to claim 21, wherein step (a) is performed on a deck of an installation vessel.

23. The method according to claim 21, wherein the assembly of (a) is transported with flanges pointing downward and each blade of the two rotor blades in separate frames.

24. The method according to claim 23, wherein the frames are suitable for holding and handling the blades for multiple wind turbines.

25. The method according to claim 21, wherein the third blade is transported with the flange pointing up and in a separate frame.

26. The method according to claim 21, wherein the blades of the rotors are transported and manipulated by a carrousel shaped frame or frames which turn the blades in the blade handling position ready for manipulation by a blade handling tool and mounting to the hub.

27. The method according to claim 21, wherein at least three rotor blades are mounted to the pre-assembly to form the assembly.

28. A blade holding frame for holding blades in a vertical position, wherein the frame is suitable for holding multiple blades in a set position during transportation on an installation vessel.

29. The blade holding frame according to claim 28, wherein the blades have their flanges pointing downward.

30. The blade holding frame according to claim 28, wherein the blades have their flanges pointing upward.

31. The blade holding frame according to claim 30, wherein the frame is designed to hold the load formed by an assembly of nacelle, hub and multiple blades and to support and suppress all required degrees of freedom relative to the frame.

32. The blade holding frame according to claim 31, such that a blade loaded in one frame can be manipulated towards the hub of the assembly of nacelle, hub and multiple blades allowing the blade to be mounted to the assembly.

33. The blade holding frame according to claim 28, comprising an access path for personnel at or near the blade holding frame.

34. The blade holding frame according to claim 28, comprising a blade handling tool capable of holding and manipulating a vertical rotor blade flanges pointing downwards, in the required degrees of freedom allowing the rotor blade to be fitted to the assembly of nacelle and hub.

35. An installation vessel comprising a deck comprising at least one pre-assembled nacelle and hub without blades is positioned at or near the center line of the vessel and the blade holding frames with blades positioned upright with the flange pointing downwards positioned at both sides of the vessel, the at least one pre-assembled nacelle and hub without blades standing in the middle between the frames.

36. The installation vessel according to claim 35, wherein at least one pre-assembled nacelle and hub without blades is positioned at any location on the deck, oriented in the middle between the blade holding frames with blades positioned upright with the flange pointing downward.

37. The installation vessel according to claim 35, wherein components for multiple wind turbines may be transported without additional blade handling for each turbine installation sequence.
